(19) United States
(12) Patent Application Publication
(10) Pub. No.: US 2004/0202002 A1
(43) Pub. Date: Oct. 14, 2004

(54) Camouflage light cover

(76) Inventors: Don Franklin Rhoad, Bamberg, SC (US); Lee Arthur Groves, Elkhart, IN (US)

Correspondence Address: Don F. Rhoad, 24 Berte Carter Drive, Bamberg, SC, 29003, US

(21) Appl. No.: 10/833,865

(22) Filed: Apr. 29, 2004

Related U.S. Application Data
(63) Continuation of application No. 09/067,886, filed on Apr. 28, 1998, now Pat. No. 6,312,145.

(51) Int. Cl. B60Q 3/00

(52) U.S. Cl. 362/507

(57) ABSTRACT

An article of manufacture for offering a device which disguises headlights and lenses of a vehicle such as a military, hunting vehicle, ATV, or the like. The inventive device includes a magnetic material, and is quickly removable when absolutely necessary. Uses fewer parts, utilizes magnetic attachment, one piece construction, unbreakable, lightweight construction, and two sided, reversible camouflage cover offers superior adaptability to surroundings. Camouflage light covers are for use with military and hunting vehicles and transportation devices to conceal the lights, fixtures, mounting equipment, and other apparatus used to secure the lights, from other people, animals, and other viewing devices. In reference to camouflage light covers, the same procedures and disclosures described in the present invention of camouflaged light covers can be extended to include any printed light covers using the same methods and techniques as those used or employed in the present invention of camouflage light covers.

### CROSS REFERENCES TO RELATED APPLICATION

This is a continuation of U.S. Pat. No. 6,312,145,B1 (Date of Patent: Nov. 6, 2001), filed Apr. 28, 1998.

This invention relates generally to the field of manufacturing, and more particularly to an article of manufacture for offering a device which disguises headlights and lenses of a vehicle such as a military, hunting vehicle, ATV, or the like. The inventive device includes a magnetic material, and is quickly removable when absolutely necessary.

### BACKGROUND OF THE INVENTION

1. Discussion of Background

As stated in prior patent US 6,312,145 B1, seasoned hunters and specialized military personnel understand the need to cover their vehicles with paint and materials that blends into the surrounding environment. Coverage of the vehicles lights with a camouflage material is especially important so that the reflection and/or glint from the lights will not give away a position. Therefore, it is important to the success of the person desiring not to be seen to effectively cover or camouflage the lights of the vehicles and other transportation devices.

2. Field of the Invention

Basically, the present invention relates to camouflage light covers for vehicles and other transportation devices. In more detail, the present invention relates to camouflage covers that attach to the headlights, tail lights, signal lights, and navigating lights of vehicles and other transportation devices.

The present invention relates to lens covers, blinds, shades, and the like and more particularly pertains to a new Camouflage Light Cover for offering a device which disguises headlights and lenses of a vehicle such as a military vehicle, hunting vehicle, ATV, or the like. The main purpose for the inventive device is for unlit lights or lights that are not in current use, where the inventive device is for taking away reflections from other light sources that happen to shine on the head light lens (lenses) or other lenses, therefore preventing revelation of location which in turn is vital to the conduction of tactical military maneuvers. The inventive device substantially eliminates or reduces glint and reflection from headlight lenses and the like.

### DESCRIPTION OF THE PRIOR ART

The use of lens covers, blinds, shades, and the like is known in the prior art. More specifically, lens covers, blinds, shades, and the like heretofore devised and utilized are known to consist basically of familiar, expected and obvious structural configurations, notwithstanding the myriad of designs encompassed by the crowded prior art which have been developed for the fulfillment of countless objectives and requirements.

Known prior art lens covers, blinds, shades, and like include U.S. Pat. No. 4,673,609; U.S. Pat. No. 5,521,655; U.S. Pat. No. 5,055,982; U.S. Pat. No. 4,894,761; U.S. Pat. No. 4,715,702; U.S. Pat. No. 4,439,817; U.S. Pat. No. 4,310,872; U.S. Pat. No. 4,225,904; U.S. Pat. No. 3,696,238; U.S. Pat. No. 3,259,737; U.S. Pat. No. 2,807,711; U.S. Pat. No. 2,734,129; U.S. Pat No. 2,596,879; U.S. Pat. No. 2,550,594; U.S. Pat. No. 2,544,378; U.S. Pat. No. 2,539,819; U.S. Pat. No. 2,499,555; and U.S. Pat. No. 1,684,720; and British Patents 2,032,417A and 2,118,096. This application is an addendum to U.S. Pat. No. 6,312,145 B1 (date of Patent Nov. 6, 2001). Don F. Rhoad, inventor, 245 Berte Carter Drive, Bamberg, S.C. (US) 29003.

While these devices fulfill their respective, particular objectives and requirements, the aforementioned patents, with the exception of U.S. Pat. No. 6,312,145 B1, do not disclose a new Camouflage Light Cover. Referring to use on military vehicles and the like, currently mud or sand bags and other objects are used to hide and cover headlight lenses. The inventive device includes a magnetic apparatus that will more efficiently cover the headlights and/or headlight lenses. The inventive device can be quickly and easily attached and/or removed from headlights and/or headlight lenses when necessary.

In these respects, the Camouflage Light Cover according to the present invention substantially departs from the conventional concepts and designs of the prior art, and in so doing provides an apparatus primarily developed for the purpose of offering a device which disguises headlights and lenses of a vehicle such as a military vehicle,hunting vehicle, ATV, or the like.

### SUMMARY OF THE INVENTION

The primary object of the invention is Cheaper to manufacture.

Another object of the invention is more durable construction.

Another object of the invention is more reliable.

A further object of the invention is less cumbersome.

Yet another object of the invention is non-reflective surface.

Still yet another object of the invention is quickly and easily attaches to vehicle surface'.

Another object of the invention is quickly and easily removable when not in use.

Another object of the invention is easy to store when not in use.

Other objects and advantages of the present invention will become apparent from the following descriptions, taken in connection with the accompanying drawings, wherein, by way of illustration and example, an embodiment of the present invention is disclosed.

An article of manufacture for offering a device which disguises headlights and lenses of a vehicle such as a military, hunting vehicle, ATV, or the like. The inventive device includes a magnetic material, and is quickly removable when absolutely necessary. comprising: uses fewer parts, utilizes magnetic attachment, one piece construction, unbreakable, lightweight construction, and two sided, reversible camouflage cover offers superior adaptability to surroundings.

Seasoned hunters and specialized military personnel understand the need to cover their vehicles with paint and materials that blends into the surrounding environment. Coverage of the vehicles lights with a camouflage material is especially important so that the reflection and/or glint from the lights will not give away a position. Therefore, it is important to the success of the person desiring not to be seen to effectively cover or camouflage the lights of the vehicles and other transportation devices.

### SUMMARY OF THE INVENTION

In view of the foregoing disadvantages inherent in the known types of lens covers, blinds, shades, and the like now present in the prior art, the present invention provides a new Camouflage Light Cover construction wherein the same can be utilized for offering a device which disguises headlights and lenses of a vehicle such as a military vehicle, hunting vehicle, ATV, or the like.

According to its major aspects and broadly stated, the present invention is camouflage covers for vehicles and other transportation devices. Further, the present invention is camouflaged light covers for vehicles and other transportation devices to conceal the reflection and/or glint from lights, fixtures, mounting equipment and other apparatus used to secure the lights to vehicles and other transportation devices from other people or other viewing devices that may view the vehicle or other transportation devices. The covers comprise a magnetic material made of rubber or other like material that attaches to the lights, fixtures, mounting equipment, and other apparatus used to secure the lights of the vehicles and other transportation devices, thus concealing the lights, fixtures, mounting equipment, and other apparatus of the vehicle and other transportation devices.

Another feature of the present invention is that the covers are preferably non-reflecting so that the reflection of the sun or other lighting sources from the covers will not give away the position of the person desiring not to be seen.

The design applied is a “camouflage” pattern. A camouflage pattern is a pattern comprised of shapes and colors intended to blend into the surrounding environment in order to conceal. The camouflage pattern can be comprised of brown, green, orange, black, white, and/or blue shades etc. and combinations thereof, and any color that blends into the terrain in which something is being concealed. The colors and shapes employed will depend on the season of the year as well as the terrain.

To make the inventive device, a camouflage pattern is applied to either side of the cover. The pattern can comprise as many different colors, as well as a solid color, as needed to adequately blend into the surrounding environment. The construction should also include other material such as rubber, plastic, burlap and metal.

In the present invention, the camouflage design is applied to a magnetic material that is suitable for making panels used for the camouflage light covers.

The general purpose of the present invention, which will be described subsequently in greater detail, is to provide a new Camouflage Light Cover apparatus and method which has many of the advantages of the lens covers, blinds, shades, and the like mentioned heretofore and many novel features that result in a new Camouflage Light Cover which is not anticipated, rendered obvious, suggested, or even implied by any of the prior art lens covers, blinds, shades, and the like, either alone or in any combination thereof.

To attain this, the present invention generally comprises a lens cover, a lanyard and snap for attachment to vehicle. The lens cover can be constructed of alternative materials such as rubber, plastic, cloth, burlap, wood, and metal.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new Camouflage Light Cover apparatus and method which has many of the advantages of the lens covers, blinds, shades, and the like mentioned heretofore and many novel features that result in a new Camouflage Light Cover which is not anticipated, rendered obvious, suggested, or even implied by any of the prior art lens covers, blinds, shades, and the like, either alone or in any combination thereof. Examples of printed light covers could include, but would not be limited to, collegiate and professional sports logos, numbers, corporate logos and other printed art work.

It is another object of the present invention to provide a new Camouflage Light Cover which may be easily and efficiently manufactured and marketed.

It is a further object of the present invention to provide a new Camouflage Light Cover which is of a durable and reliable construction.

An even further object of the present invention is to provide a new Camouflage Light Cover which is susceptible of a low cost of manufacture with regard to both materials and labor, and which accordingly is then susceptible of low prices of sale to the consuming public, thereby making such Camouflage Light Cover economically available to the buying public.

Still yet another object of the present invention is to provide a new Camouflage Light Cover which provides in the apparatuses and methods of the prior art some of the advantages thereof, while simultaneously overcoming some of the disadvantages normally associated therewith.

Still another object of the present invention is to provide a new Camouflage Light Cover for offering a device which disguises headlights and lenses of a vehicle such as a military vehicle, hunting vehicle, ATV, or the like.

Yet another object of the present invention is to provide a new Camouflage Light Cover which includes a lens cover formed from a magnetic material, a lanyard and a means of attachment to the vehicle, and is quickly and easily removable when absolutely necessary.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there is illustrated preferred embodiments of the invention.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### BRIEF DESCRIPTION OF THE DRAWING

The invention will be better understood and objects other than those set forth above will become apparent when consideration is given to the following detailed description thereof. Such description makes reference to the annexed drawing within:

FIG. 1 is a front side perspective view of a new Camouflage Light Cover according to the present invention.

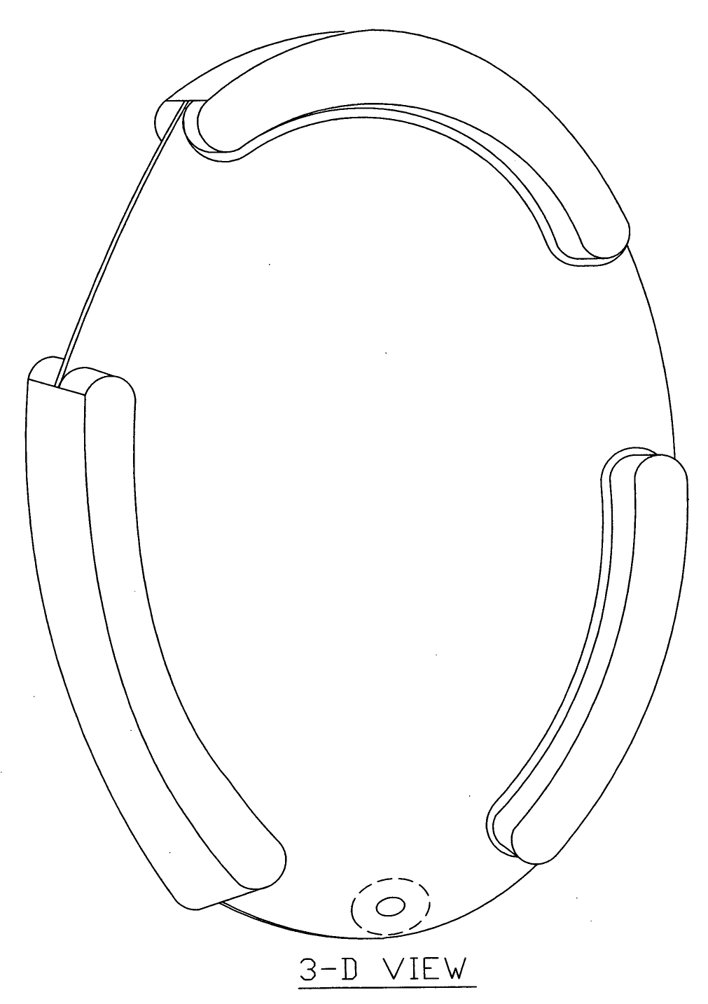

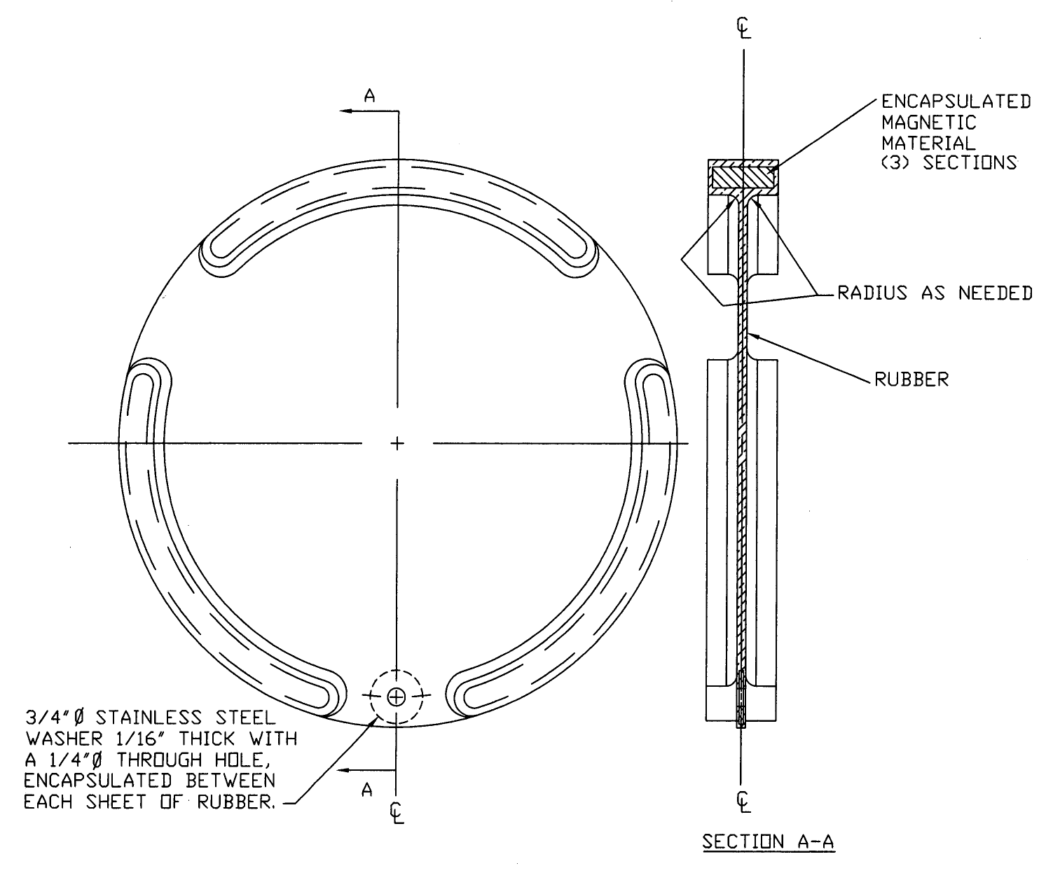

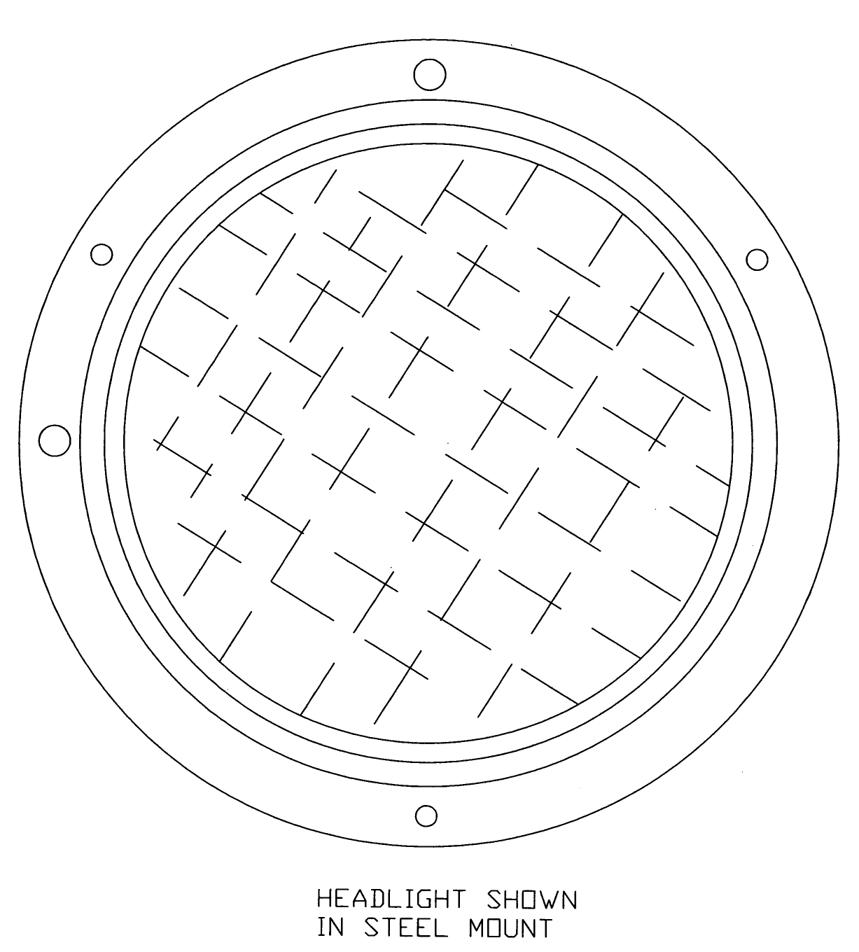

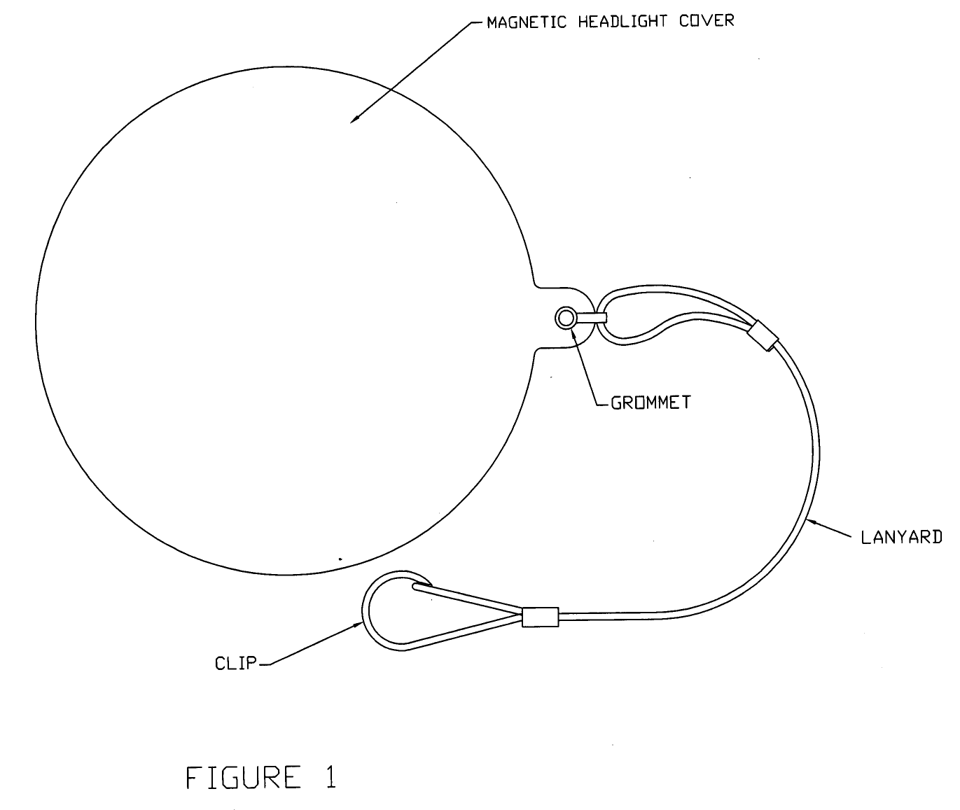

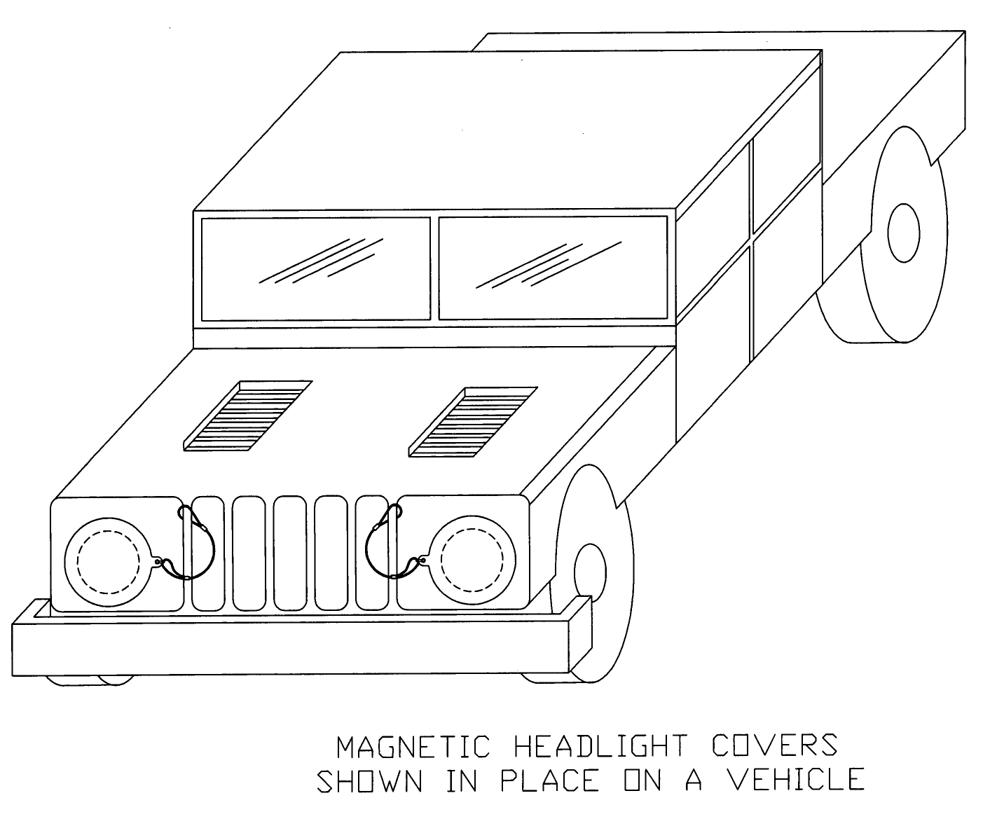

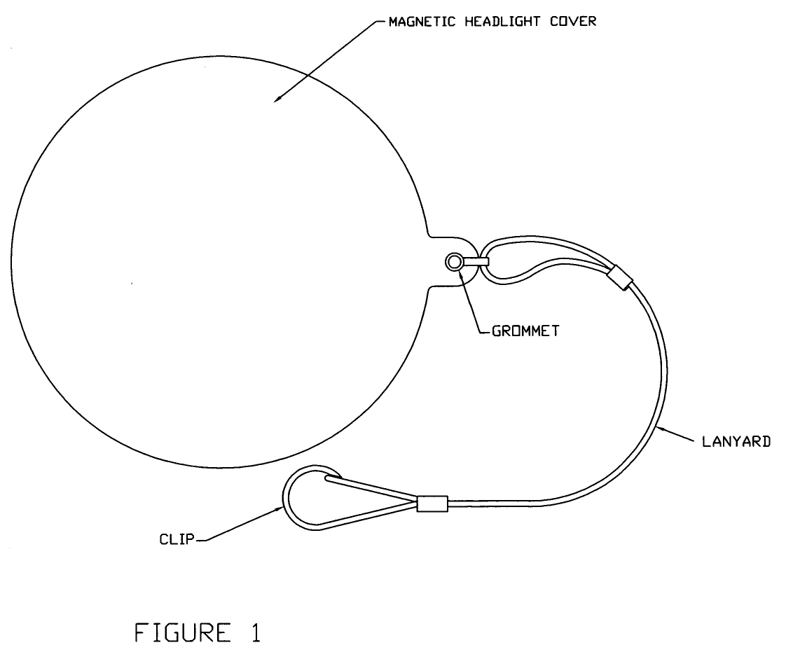

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

With reference now to the drawing, a new Camouflage Light Cover embodying the principles and concepts of the present invention.

More specifically, it will be noted that the Camouflage Light Cover comprises a magnetic lens cover, a means of attachment, thus allowing the attachment of a lanyard to the magnetic lens cover on one end of the lanyard and a clip, snap, or other means of fastening on the other end of the lanyard, in which the lanyard can be attached to the vehicle, thus securing the magnetic lens cover to the vehicle, particularly when Camouflage Light Cover is not in use.

As to a further discussion of the manner of usage and operation of the present invention, the same should be apparent from the above description. Accordingly, no further discussion relating to the manner of usage and operation will be provided. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. An article of manufacture for offering a device which disguises headlights and lenses of a vehicle such as a military, hunting vehicle, ATV, or the like. The inventive device includes a magnetic material, and is quickly removable when absolutely necessary. comprising:
fewer parts;
utilizes magnetic attachment;
one piece construction;
unbreakable;
lightweight construction; and
two sided, reversible camouflage cover offers superior adaptability to surroundings.
Seasoned hunters and specialized military personnel understand the need to cover their vehicles with paint and materials that blends into the surrounding environment. Coverage of the vehicles lights with a camouflage material is especially important so that the reflection and/or glint from the lights will not give away a position. Therefore, it is important to the success of the person desiring not to be seen to effectively cover or camouflage the lights of the vehicles and other transportation devices.
